(19) United States
(12) Patent Application Publication
(10) Pub. No.: US 2022/0245409 A1
(43) Pub. Date: Aug. 4, 2022

(54) ANCHOR WINDOW SIZE AND POSITION SELECTION IN TIME SERIES REPRESENTATION LEARNING

(71) Applicant: International Business Machines Corporation, Armonk, NY (US)

(72) Inventors: Venkata Nagaraju Pavuluri, New Rochelle, NY (US); Dharmashankar Subramanian, White Plains, NY (US); Yuan-Chi Chang, Armonk, NY (US); Long Vu, Chappaqua, NY (US); Timothy Rea Dinger, Croton-on=Hudson, NY (US)

(21) Appl. No.: 17/162,649

(22) Filed: Jan. 29, 2021

(51) Int. Cl. G06K 9/62; G06N 20/00; G06F 17/18; G06F 7/24

(52) U.S. Cl. CPC G06K 9/6296; G06K 9/6228; G06F 7/24; G06F 17/18; G06N 20/00

(57) ABSTRACT

A method of using a computing device to determine a window size in variate time series data that includes receiving, by a computing device, variate time series data associated with a machine learning model. The computing device sets a moving window size and a standard deviation for the variate time series data. The computing device further calculates a moving window average for the variate time series data. The computing device additionally calculates a standard deviation across all variate time series data. The computing device sorts the standard deviations calculated in descending order. The computing device further iterates indices for the standard deviations until the indices have been visited by at least one anchor. The computing device iteratively expands each anchor to cover neighbors' anchors which have been visited by previous anchors. The computing device determines a window size based upon the expanded anchors.

### BACKGROUND

The field of embodiments of the present invention relates to using a computing device to determine a window size in unvariate or multivariate time series data.

Representation learning has proven effective for learning essential features that capture the salient characteristics of data in many domains. Specifically, triple-loss based representation learning involves a “triplet loss,” namely a loss function for artificial neural networks where a baseline (anchor) input is compared to a positive (likely true) input and a negative (likely false) input, and the representation is learned such that the distance from the baseline (anchor) input to the positive (likely true) input is minimized in the representation space, and the distance from the baseline (anchor) input to the negative (likely false) input is maximized (in the representation space).

Conventional state of the art time series representation learning (RL) follows a dilated temporal convolutional neural network (CNN) architecture with triplet loss, where anchor windows are chosen randomly in position and size, positive samples are randomly chosen within the anchor windows, and negative samples are randomly chosen outside the anchor windows. While random positives/negatives allow for easy assembly of triplets, the conventional time series RL only emphasize self-similarity in selecting positives, and leave dissimilarity negatives completely to chance.

### SUMMARY

Embodiments relate to using a computing device to select anchor window size and position in triplet loss formulation of time series representation machine learning (ML) of variate time series data. One embodiment provides a method of using a computing device to determine a window size in variate time series data that includes receiving, by a computing device, variate time series data associated with a machine learning model. The computing device sets a moving window size and a standard deviation for the variate time series data. The computing device further calculates a moving window average for the variate time series data. The computing device additionally calculates a standard deviation across all variate time series data. The computing device sorts the standard deviations calculated in descending order. The computing device further iterates indices for the standard deviations until the indices have been visited by at least one anchor. The computing device iteratively expands each anchor to cover neighbors' anchors which have been visited by previous anchors. The computing device determines a window size based upon the expanded anchors. Some features contribute to the advantage of reducing wide variations measured in classification accuracy and across ML training runs. Other features contribute to the advantage of improving representation ML, especially for more difficult datasets, in accuracy average and range across training runs. Some features contribute to the advantage of converging optimization of results faster than conventional techniques and is less likely get trapped in a poor local minimum. Some embodiments provide the practical benefit in ML automation to reduce automation search time, and reduce the number of representation ML executions to reduce computing time. One or more embodiments provide for improved confidence upon ML execution that needs to be stopped early.

One or more of the following features may be included. In some embodiments, the method may further include that the variate time series data is univariate time series data or multivariate time series data.

In some embodiments, the method may additionally include the window size is implemented in triplet loss formulation of representation machine learning of the variate time series data.

In one or more embodiments, the method may further include setting a beginning and end of a next window size using a largest standard deviation and current window size.

In some embodiments, the method may additionally include marking, by the computing device, the window size positions between the beginning and end.

In one or more embodiments, the method may include that iteratively expanding, by the computing device, the moving window size to its neighbors whose standard deviation exceeds a threshold.

In some embodiments, the method may further include selecting, by the computing device, a next largest standard deviation whose position has not been visited by the previous anchors; and ending processing, by the computing device, upon visiting all positions in a window-based moving average vector.

These and other features, aspects and advantages of the present embodiments will become understood with reference to the following description, appended claims and accompanying figures.

### BRIEF DESCRIPTION OF THE DRAWINGS

FIG. 1 shows a flow diagram for selecting anchor window size and position in triplet loss formulation of time series representation machine learning (ML) of univariate time series data processing, according to one embodiment;

FIG. 2 shows a flow diagram for selecting anchor window size and position in triplet loss formulation of time series representation ML of multivariate time series data processing, according to one embodiment;

FIG. 3 shows a computing process for variance driven triplet anchor window selection ML learning processing, according to one embodiment;

FIG. 4A shows graphs for different classes from a training set;

FIG. 4B shows a graph for standard deviations of moving average over a certain window size for the graphs in FIG. 4A, according to one embodiment;

FIG. 5A shows graphs for different classes from another training set;

FIG. 5B shows a graph for standard deviations of moving average over a certain window size for the graphs in FIG. 5A, according to one embodiment;

FIG. 6 illustrates a block diagram of a process for determining anchor windows for triplet loss formulation of representation ML learning of univariate or multivariate time series processing, according to one embodiment;

FIG. 7 depicts a cloud computing environment, according to an embodiment;

FIG. 8 depicts a set of abstraction model layers, according to an embodiment;

FIG. 9 is a network architecture of a system for determining anchors in triplet loss formulation of representation ML learning of univariate or multivariate time series processing, according to an embodiment;

FIG. 10 shows a representative hardware environment that may be associated with the servers and/or clients of FIG. 7, according to an embodiment; and

FIG. 11 is a block diagram illustrating a distributed system for determining anchors in triplet loss formulation of representation ML learning of univariate or multivariate time series processing, according to one embodiment.

### DETAILED DESCRIPTION

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments relate to using a computing device to select anchor window size and position in triplet loss formulation of time series representation machine learning (ML) of variate time series data. One embodiment provides a method of using a computing device to determine a window size in variate time series data that includes receiving, by a computing device, variate time series data associated with a machine learning model. The computing device sets a moving window size and a standard deviation for the variate time series data. The computing device further calculates a moving window average for the variate time series data. The computing device additionally calculates a standard deviation across all variate time series data. The computing device sorts the standard deviations calculated in descending order. The computing device further iterates indices for the standard deviations until the indices have been visited by at least one anchor. The computing device iteratively expands each anchor to cover neighbors' anchors which have been visited by previous anchors. The computing device determines a window size based upon the expanded anchors. Some features contribute to the advantage of reducing wide variations measured in classification accuracy and across ML training runs. Other features contribute to the advantage of improving representation ML, especially for more difficult datasets, in accuracy average and range across training runs. Some features contribute to the advantage of converging optimization of results faster than conventional techniques and is less likely get trapped in a poor local minimum. Some embodiments provide the practical benefit in ML automation to reduce automation search time, and reduce the number of representation ML executions to reduce computing time. One or more embodiments provide for improved confidence upon ML execution that needs to be stopped early. Some embodiments, provide a selection of anchors for triplet loss function minimization.

One or more of the following features may be included. In some embodiments, the method may further include that the variate time series data is univariate time series data or multivariate time series data.

In some embodiments, the method may additionally include the window size is implemented in triplet loss formulation of representation machine learning of the variate time series data.

In one or more embodiments, the method may further include setting a beginning and end of a next window size using a largest standard deviation and current window size.

In some embodiments, the method may additionally include marking, by the computing device, the window size positions between the beginning and end.

In one or more embodiments, the method may include that iteratively expanding, by the computing device, the moving window size to its neighbors whose standard deviation exceeds a threshold.

In some embodiments, the method may further include selecting, by the computing device, a next largest standard deviation whose position has not been visited by the previous anchors; and ending processing, by the computing device, upon visiting all positions in a window-based moving average vector.

One or more embodiments include a model for processing (e.g., for process 100, process 200, process 300, etc.) that employs one or more artificial intelligence (AI) models. AI models may include a trained ML model (e.g., models, such as a neural network (NN), a convolutional NN (CNN), a recurrent NN (RNN), a Long short-term memory (LSTM) based NN, gate recurrent unit (GRU) based RNN, tree-based CNN, a self-attention network (e.g., a NN that utilizes the attention mechanism as the basic building block; self-attention networks have been shown to be effective for sequence modeling tasks, while having no recurrence or convolutions), BiLSTM (bi-directional LSTM), etc.). An artificial NN is an interconnected group of nodes or neurons.

Existing approaches seek to fit image-based triplet generation to time series, such as cropping/cutting/translating the anchor image (e.g., sub-sampling the anchor for positives), and choosing a random image (e.g., choosing a random time series interval for negatives). Unlike images, numerical time series offer more natural measures of similarity and contrast. One or more embodiments may be implemented with positive and negative sample selection for triplet training. In one embodiment, window selection is implemented for an original triple loss function that uses a single (self-sub-sampled) positive sample is modified to the more general case of multiple positive samples, which are also not restricted to be self-sub-sampled.

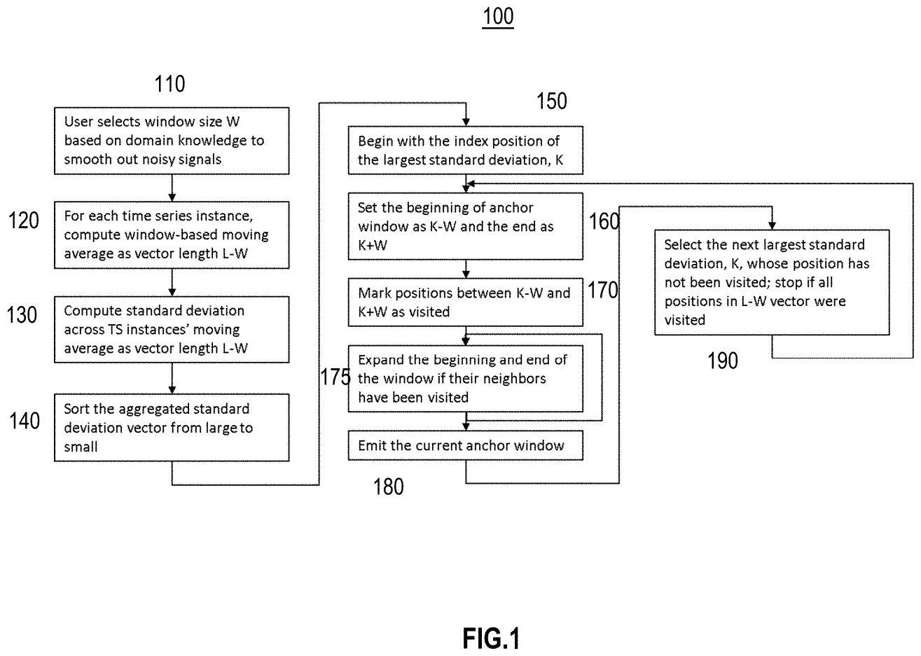

FIG. 1 shows a flow diagram for selecting anchor window size and position in triplet loss formulation of time series representation ML of univariate time series data processing 100, according to one embodiment. State of the art time series representation learning follows CNN architectures of image, text representation learning. In conventional techniques, anchor convolutional windows in images, anchor word windows (spans) in sentences, and anchor time windows in time series are each chosen randomly in position and size. Unlike image and text corpus, practical time series problems have fewer examples to learn effectively through random selection. One problem with conventional techniques is that random anchor window selection leads to wide variations, measured in classification accuracy, across training runs.

In one embodiment, in block 110 the processing 100 includes selecting (or setting) a moving average window size W based on domain knowledge to smooth out noisy signals. In a time series, a “window” is an interval of data, such as a two-dimensional matrix, m×s, where m is the dimensionality of the time series, and s is the number of time-steps in the interval. In one embodiment, a standard deviation threshold (σ) is set. In block 120, for each time series instance, the window-based moving average window size is computed as a vector length L-W. In block 130, processing 100 computes a standard deviation across time series instances' (e.g., at each index, K, in a ML training set) moving average as vector length L-W. In block 140, the aggregated standard deviation vector is sorted in descending order. In block 150, processing 100 begins with an index position of the largest standard deviation, K. In block 160, processing 100 sets the beginning of the anchor window as K−W and the end as K+W. In block 170, processing 100 marks (e.g., sets a flag (e.g., True, False, etc.), a bit (0, 1), etc.) positions between K−W and K+W indices as visited (by at least one anchor) for each iteration until all indices are visited. In block 175, processing 100 iteratively expands the beginning K−W and end K+W of the anchor window if their neighbors have been visited (by at least one anchor). In one embodiment, block 175 may also expand the anchor window to its neighbors that have a standard deviation greater than σ. In block 180, processing 100 outputs (or emits) the current anchor window. In block 190, processing 100 selects (or sets) the next largest standard deviation, K, whose position has not been visited; and processing 100 stops upon all positions in the L-W vector were visited; otherwise the processing 100 proceeds back to block 160 to continue processing 100.

In one embodiment, processing 100 provides static anchor window selection to improve and narrow representation ML variations during ML model training. Distinguishable from images and sentences, one embodiment provides that processing 100 performs contrastive algebraic operations on numerical time series information. In one or more embodiments, anchor windows are selected through local variance, or broadly contrastive statistical measures. Processing 100 improves representation ML, especially for more difficult datasets, in accuracy average and range across training runs. In one embodiment, processing 100 converges faster than conventional techniques and is less likely get trapped in a poor local minimum. Some embodiments provide the practical benefit in ML automation to reduce automation search time, and reduce the number of representation ML execution reduce computing time. One or more embodiments provide for improved confidence upon ML execution that needs to be stopped early.

In one embodiment, the processing 100 may be implemented in ML anchor selection for univariate or multivariate time series as follows. Within the anchor, a sample of random length and position is selected and referred to as a positive universe. In one embodiment, the anchor is selected using a suitable selection protocol from each time series object in a training batch of multiple time series objects. In one embodiment, the selection protocol may include a selection of a random sub-interval of a corresponding length, for each time series object in a training batch of multiple time series objects. In some embodiments, the anchor selection includes using a local variance based selection protocol that systematically sweeps through the entire time series and produces a sequence of anchor objects, chosen one at a time across batches, for each time series object included in a training batch of multiple time series objects.

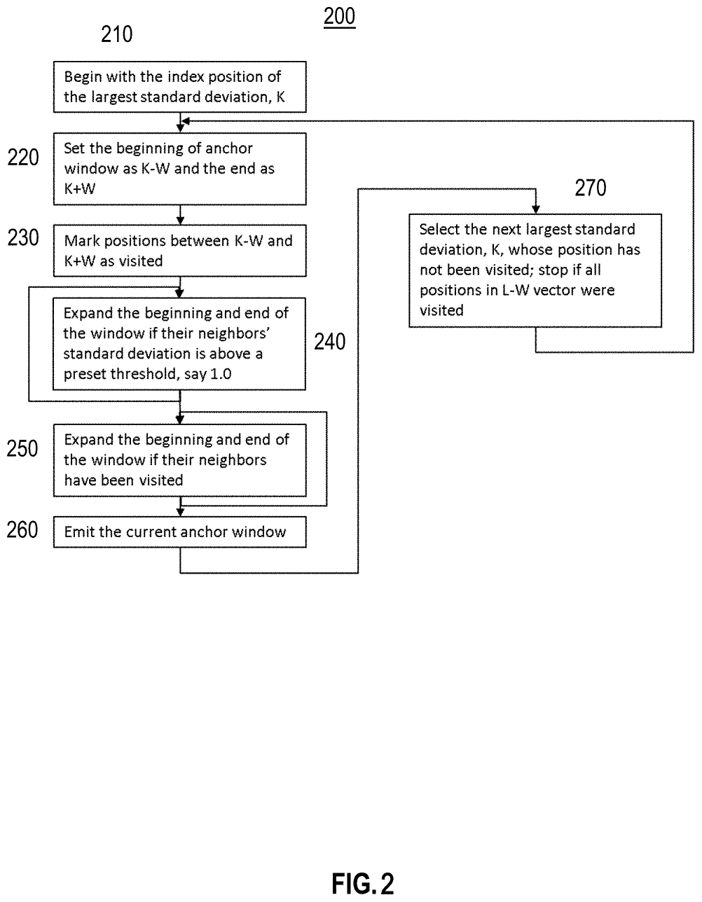

FIG. 2 shows a flow diagram for selecting anchor window size and position in triplet loss formulation of time series representation ML of multivariate time series data processing 200, according to one embodiment. In one embodiment, in block 210 the processing 200 includes beginning with the index position of the largest standard deviation K. In block 220, processing 200 sets the beginning of an anchor window as K−W and the end as K+W. In block 230, processing 200 marks (e.g., sets a flag (e.g., True, False, etc.), a bit (0, 1), etc.) positions between K−W and K+W indices as visited (by at least one anchor) for each iteration until all indices are visited. In block 240, processing 200 iteratively (iterates until all indices have been visited by at least one anchor) expands the beginning K−W and end K+W of the anchor window if their neighbors' standard deviation is above a preset threshold (e.g., 1.0, etc.). In block 250, process 200 iteratively expands the beginning K−W and the end K+W of the anchor window if their neighbors have been visited (by at least one anchor). In block 260, processing 200 outputs (or emits) the current anchor window. In block 270, processing 200 selects (or sets) the next largest standard deviation, K, whose position has not been visited; and processing 200 stops upon all positions in the L-W vector were visited; otherwise the processing 200 proceeds back to block 220 to continue processing 200.

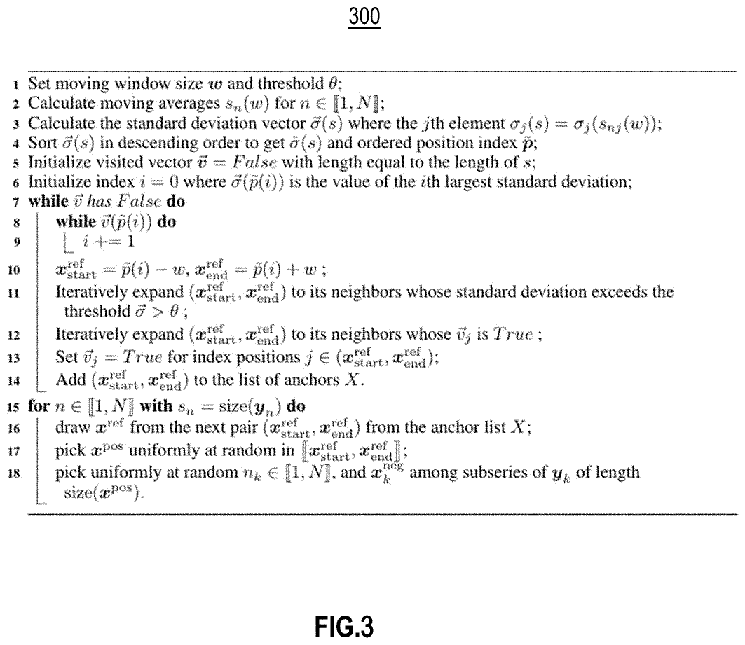

FIG. 3 shows a computing process 300 for variance driven triplet anchor window selection ML learning processing, according to one embodiment. In one embodiment, the process 300 progressively selects the anchor (x^{ref}) covering periods of the largest variance and expands coverage at each ML iteration. In one embodiment, process 300 iteratively expands (xₛₜₐᵣₜ^{ref}, x_{end}^{ref}) to its neighbors whose standard deviation exceeds the threshold \vec{σ} (the standard deviation vector)>θ (standard deviation threshold). Process 300 also iteratively expands (xₛₜₐᵣₜ^{ref}, x_{end}^{ref}) to its neighbors whose \vec{vⱼ} (visited vector) has a True value. In one embodiment, \vec{vⱼ} (visited vector) records indices which have been covered by previous, larger variance anchor windows.

In one embodiment, some advantages and benefits are that variance driven triplet anchor window selection ML learning for process 300 improved accuracy for univariate data set with accuracy range >5% across training runs, improved average accuracy in 85% of datasets and narrowed the range in 74% of datasets. Some embodiments improve representation learning, especially for more difficult datasets, in accuracy maximum, average and range across training runs. In one embodiment, the process 300 exploits the numerical operations that are natural to time series, instead of force-fitting it to ideas from image processing. One embodiment provides distance based positive sample mining that is more robust than self-similarity/sub-sampling alone, and yields a richer set of similar time intervals. In one embodiment, a practical benefit in ML automation reduces automation search time, reduces the number of representation learning executions to save compute time, provides a better confidence if learning execution needs to be stopped early, and provides a more sophisticated addition to a feature engineering toolbox. Additionally, one or more embodiments may be generalized to select anchors for RL based on training data statistics.

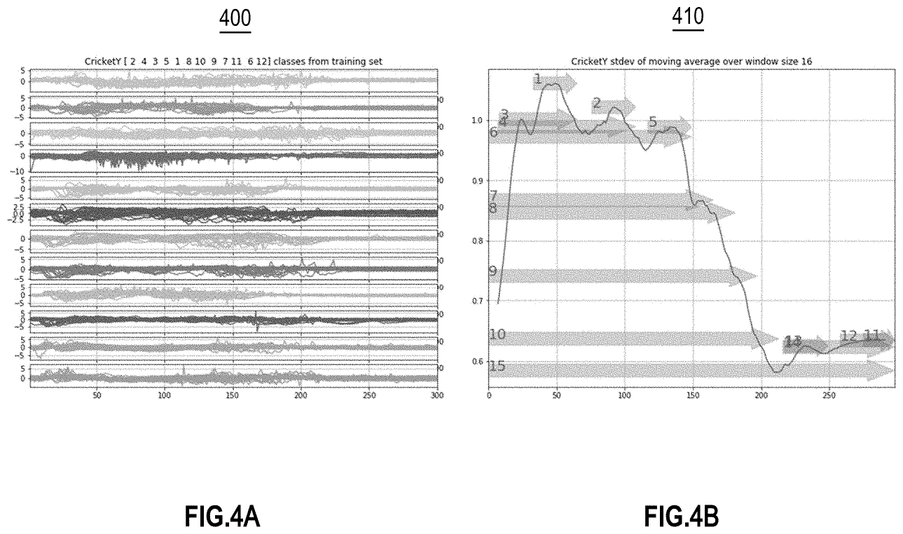

FIG. 4A shows example graphs 400 for twelve (12) different classes from a training set. The different classes (from top to bottom) are named (2 4 3 5 1 8 10 9 7 11 6 12) from the training set (e.g., accelerometer data in three dimensions). When presented with a new time series that originated from accelerometer, ML seeks to classify the new series to one of the twelve classes.

FIG. 4B shows a graph 410 for standard deviations of moving average over a certain window size for the graphs in FIG. 4A, according to one embodiment. In the graph 410, the anchor windows identified by process 300 (FIG. 3) are labeled with numerals 1 to 15 in the graph 410. The anchor window labeled with numeral 1 is located at the segment of the training data where the largest contrast occurs. The anchor window labeled with numeral 2 is located at the segment of the training data where the second largest contrast occurs. Following the process 300, subsequent anchor windows are positioned at lower and lower contrast segments, and eventually cover the full series in its entirety. The minimal anchor window length, W, is set at 16 in this illustrative example.

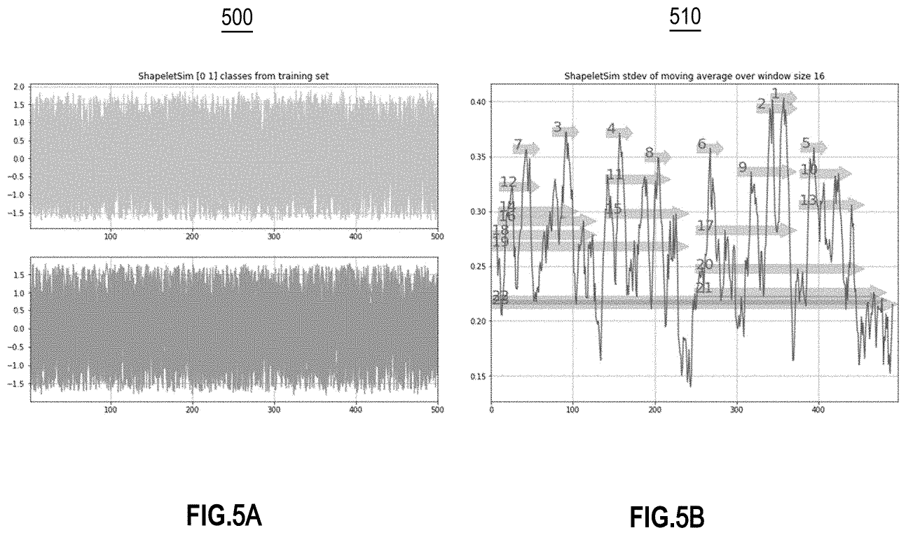

FIG. 5A shows graphs 500 for different classes from another training set. For the graphs 500, the training set is a simulated dataset designed for shapelets. The classes (0 1) are used and shown from top to bottom. In contrast to FIG. 4A, this dataset is visually more noisy and difficult to distinguish by human inspection. However, this dataset may be learned using process 300 (FIG. 3) to accurately classify the two classes.

FIG. 5B shows a graph 510 for standard deviations of moving average over a certain window size for the graphs 500 in FIG. 5A, according to one embodiment. In the graph 510, the standard deviations are labeled with numerals 1 to 23 for standard deviations of moving average over a window size 16. Similar to the label convention shown in graph 410 (FIG. 4B), the anchor window labeled with numeral 1 is located at the segment of the training data where the largest contrast occurs. Subsequent anchor windows are incrementally identified at lower and lower contrast segments and eventually cover the full series in its entirety.

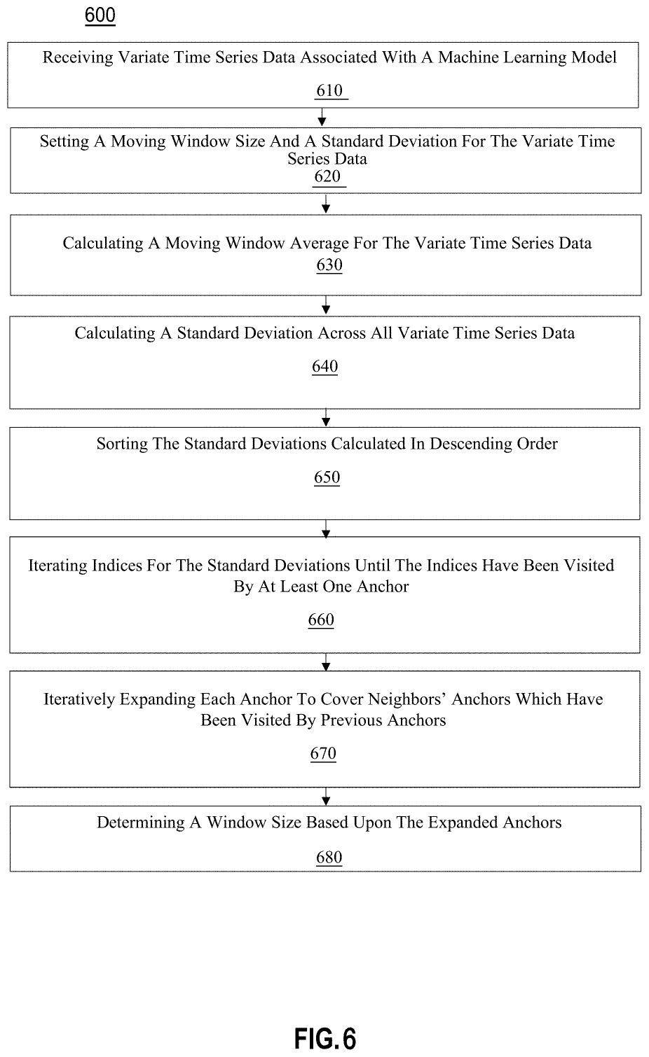

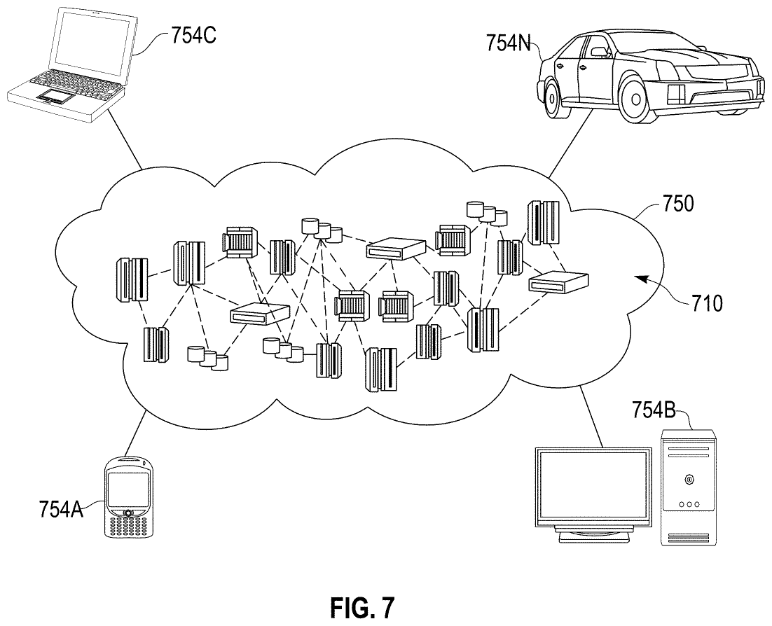

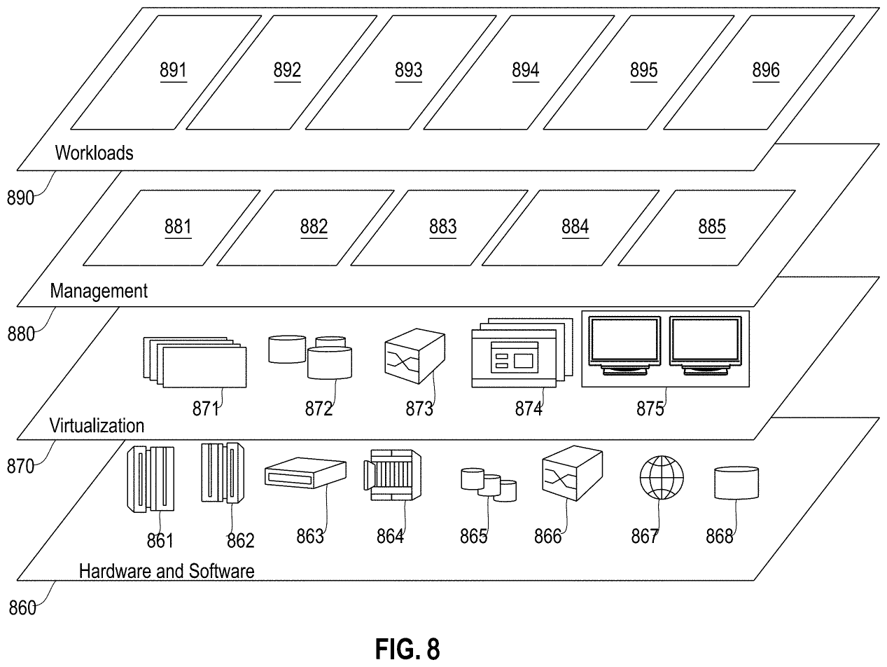

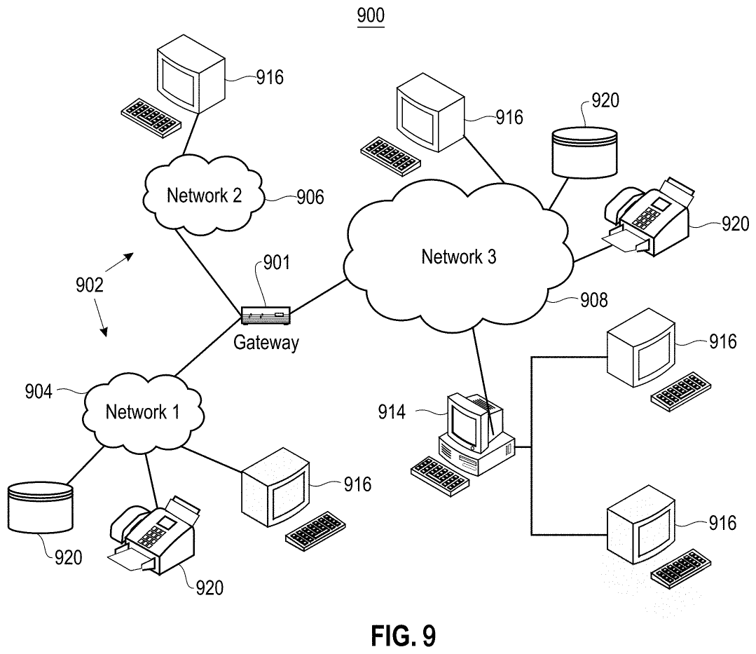

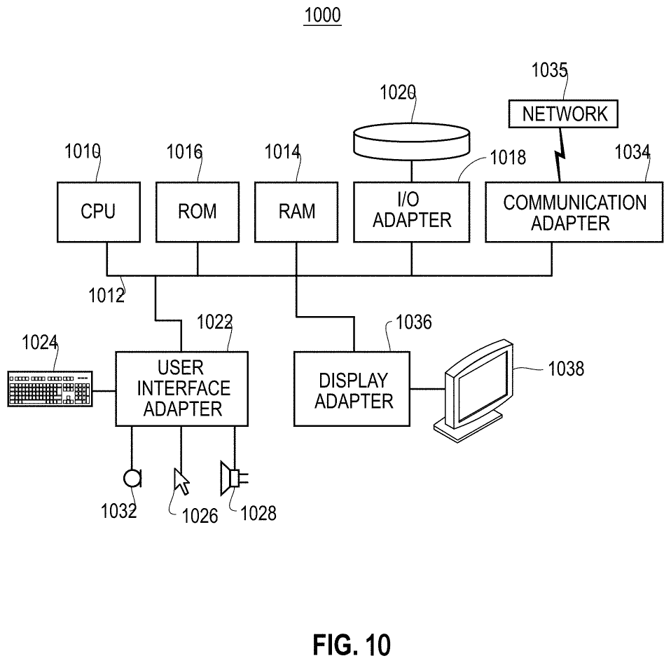

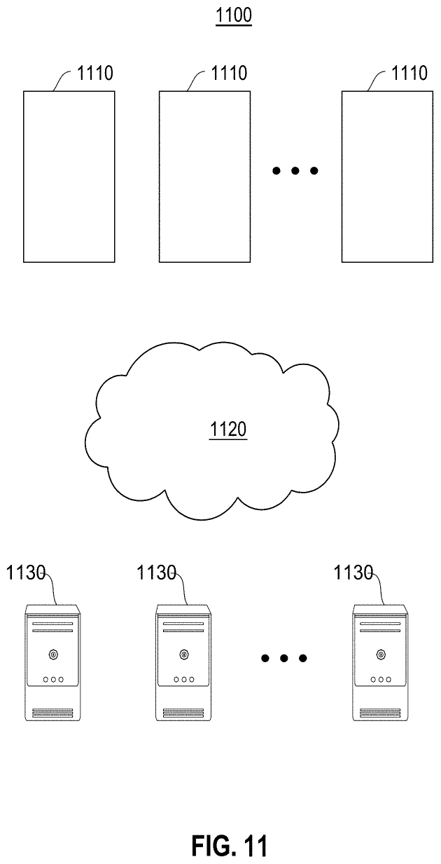

FIG. 6 illustrates a block diagram of a process 600 for determining anchor windows for triplet loss formulation of representation ML learning of univariate or multivariate time series processing, according to one embodiment. In one embodiment, in block 610, process 600 receives, by a computing device (from computing node 710, FIG. 7, hardware and software layer 860, FIG. 8, processing system 900, FIG. 9, system 1000, FIG. 10, system 1100, FIG. 11, etc.), variate time series data associated with a machine learning model. In block 620, process 600 further provides setting, by the computing device, a moving window size and a standard deviation for the variate time series data. In block 630, process 600 still further provides calculating, by the computing device, a moving window average for the variate time series data. In block 640, process 600 provides calculating, by the computing device, a standard deviation across all variate time series data. In block 650, process 600 further provides sorting, by the computing device, the standard deviations calculated in descending order. In block 660, process 600 additionally provides iterating, by the computing device, indices for the standard deviations until the indices have been visited by at least one anchor. In block 670, process 600 further provides iteratively expanding, by the computing device, each anchor to cover neighbors' anchors which have been visited by previous anchors. In block 680, process 600 further provides determining, by the computing device, a window size based upon the expanded anchors.

In one embodiment, process 600 may further include the feature that the variate time series data is univariate time series data or multivariate time series data.

In one embodiment, process 600 may further include the feature that the window size is implemented in triplet loss formulation of representation machine learning of the variate time series data.

In one embodiment, process 600 may include that the iterating further includes setting a beginning and end of a next window size using a largest standard deviation and current window size.

In one embodiment, process 600 may further include marking, by the computing device, the window size positions between the beginning and end.

In one embodiment, process 600 may further include iteratively expanding, by the computing device, the moving window size to its neighbors whose standard deviation exceeds a threshold.

In one embodiment, process 600 may further include selecting, by the computing device, a next largest standard deviation whose position has not been visited by the previous anchors, and ending processing, by the computing device, upon visiting all positions in a window-based moving average vector.

It is understood in advance that although this disclosure includes a detailed description of cloud computing, implementation of the teachings recited herein are not limited to a cloud computing environment. Rather, embodiments of the present embodiments are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service Models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

Referring now to FIG. 7, an illustrative cloud computing environment 750 is depicted. As shown, cloud computing environment 750 comprises one or more cloud computing nodes 710 with which local computing devices used by cloud consumers, such as, for example, personal digital assistant (PDA) or cellular telephone 754A, desktop computer 754B, laptop computer 754C, and/or automobile computer system 754N may communicate. Nodes 710 may communicate with one another. They may be grouped (not shown) physically or virtually, in one or more networks, such as private, community, public, or hybrid clouds as described hereinabove, or a combination thereof. This allows the cloud computing environment 750 to offer infrastructure, platforms, and/or software as services for which a cloud consumer does not need to maintain resources on a local computing device. It is understood that the types of computing devices 754A-N shown in FIG. 7 are intended to be illustrative only and that computing nodes 710 and cloud computing environment 750 can communicate with any type of computerized device over any type of network and/or network addressable connection (e.g., using a web browser).

Referring now to FIG. 8, a set of functional abstraction layers provided by the cloud computing environment 750 (FIG. 7) is shown. It should be understood in advance that the components, layers, and functions shown in FIG. 8 are intended to be illustrative only and embodiments are not limited thereto. As depicted, the following layers and corresponding functions are provided:

Hardware and software layer 860 includes hardware and software components. Examples of hardware components include: mainframes 861; RISC (Reduced Instruction Set Computer) architecture based servers 862; servers 863; blade servers 864; storage devices 865; and networks and networking components 866. In some embodiments, software components include network application server software 867 and database software 868.

Virtualization layer 870 provides an abstraction layer from which the following examples of virtual entities may be provided: virtual servers 871; virtual storage 872; virtual networks 873, including virtual private networks; virtual applications and operating systems 874; and virtual clients 875.

In one example, a management layer 880 may provide the functions described below. Resource provisioning 881 provides dynamic procurement of computing resources and other resources that are utilized to perform tasks within the cloud computing environment. Metering and pricing 882 provide cost tracking as resources are utilized within the cloud computing environment and billing or invoicing for consumption of these resources. In one example, these resources may comprise application software licenses. Security provides identity verification for cloud consumers and tasks as well as protection for data and other resources. User portal 883 provides access to the cloud computing environment for consumers and system administrators. Service level management 884 provides cloud computing resource allocation and management such that required service levels are met. Service Level Agreement (SLA) planning and fulfillment 885 provide pre-arrangement for, and procurement of, cloud computing resources for which a future requirement is anticipated in accordance with an SLA.

Workloads layer 890 provides examples of functionality for which the cloud computing environment may be utilized. Examples of workloads and functions which may be provided from this layer include: mapping and navigation 891; software development and lifecycle management 892; virtual classroom education delivery 893; data analytics processing 894; transaction processing 895; and for using a computing device to determine anchor windows for triplet loss formulation of representation learning of univariate or multivariate time series processing 896 (see, e.g., process 100, FIG. 1, process 200, FIG. 2, process 300, FIG. 3, system 900, FIG. 9, system 1000, FIG. 10, system 1100, FIG. 11). As mentioned above, all of the foregoing examples described with respect to FIG. 9 are illustrative only, and the embodiments are not limited to these examples.

It is reiterated that although this disclosure includes a detailed description on cloud computing, implementation of the teachings recited herein are not limited to a cloud computing environment. Rather, the embodiments may be implemented with any type of clustered computing environment now known or later developed.

FIG. 9 is a network architecture of a system 900 for using a computing device to train a NN to recognize features in univariate or multivariate time series data processing, according to an embodiment, according to an embodiment. As shown in FIG. 9, a plurality of remote networks 902 are provided, including a first remote network 904 and a second remote network 906. A gateway 901 may be coupled between the remote networks 902 and a proximate network 908. In the context of the present network architecture 900, the networks 904, 906 may each take any form including, but not limited to, a LAN, a WAN, such as the Internet, public switched telephone network (PSTN), internal telephone network, etc.

In use, the gateway 901 serves as an entrance point from the remote networks 902 to the proximate network 908. As such, the gateway 901 may function as a router, which is capable of directing a given packet of data that arrives at the gateway 901, and a switch, which furnishes the actual path in and out of the gateway 901 for a given packet.

Further included is at least one data server 914 coupled to the proximate network 908, which is accessible from the remote networks 902 via the gateway 901. It should be noted that the data server(s) 914 may include any type of computing device/groupware. Coupled to each data server 914 is a plurality of user devices 916. Such user devices 916 may include a desktop computer, laptop computer, handheld computer, printer, and/or any other type of logic-containing device. It should be noted that a user device 916 may also be directly coupled to any of the networks in some embodiments.

A peripheral 920 or series of peripherals 920, e.g., facsimile machines, printers, scanners, hard disk drives, networked and/or local storage units or systems, etc., may be coupled to one or more of the networks 904, 906, 908. It should be noted that databases and/or additional components may be utilized with, or integrated into, any type of network element coupled to the networks 904, 906, 908. In the context of the present description, a network element may refer to any component of a network.

According to some approaches, methods and systems described herein may be implemented with and/or on virtual systems and/or systems, which emulate one or more other systems, such as a UNIX® system that emulates an IBM® z/OS environment, a UNIX® system that virtually hosts a MICROSOFT® WiNDOWS® environment, a MICROSOFT® WINDOWS® system that emulates an IBM® z/OS environment, etc. This virtualization and/or emulation may be implemented through the use of VMWARE® software in some embodiments.

FIG. 10 shows a representative hardware system 1000 environment associated with a user device 916 and/or server 914 of FIG. 9, in accordance with one embodiment. In one example, a hardware configuration includes a workstation having a central processing unit 1010, such as a microprocessor, and a number of other units interconnected via a system bus 1012. The workstation shown in FIG. 10 may include a Random Access Memory (RAM) 1014, Read Only Memory (ROM) 1016, an I/O adapter 1018 for connecting peripheral devices, such as disk storage units 1020 to the bus 1012, a user interface adapter 1022 for connecting a keyboard 1024, a mouse 1026, a speaker 1028, a microphone 1032, and/or other user interface devices, such as a touch screen, a digital camera (not shown), etc., to the bus 1012, communication adapter 1034 for connecting the workstation to a communication network 1035 (e.g., a data processing network) and a display adapter 1036 for connecting the bus 1012 to a display device 1038.

In one example, the workstation may have resident thereon an operating system, such as the MICROSOFT® WINDOWS® Operating System (OS), a MAC OS®, a UNIX® OS, etc. In one embodiment, the system 1000 employs a POSIX® based file system. It will be appreciated that other examples may also be implemented on platforms and operating systems other than those mentioned. Such other examples may include operating systems written using JAVA®, XML, C, and/or C++ language, or other programming languages, along with an object oriented programming methodology. Object oriented programming (OOP), which has become increasingly used to develop complex applications, may also be used.

FIG. 11 is a block diagram illustrating a distributed system 1100 for using a computing device to train a NN to recognize features in univariate or multivariate time series data processing, according to one embodiment. In one embodiment, the system 1100 includes client devices 1110 (e.g., mobile devices, smart devices, computing systems, etc.), a cloud or resource sharing environment 1120 (e.g., a public cloud computing environment, a private cloud computing environment, a data center, etc.), and servers 1130. In one embodiment, the client devices 1110 are provided with cloud services from the servers 1130 through the cloud or resource sharing environment 1120.

One or more embodiments may be a system, a method, and/or a computer program product at any possible technical detail level of integration. The computer program product may include a computer readable storage medium (or media) having computer readable program instructions thereon for causing a processor to carry out aspects of the present embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers A network adapter card or network interface in each computing/processing device receives computer readable program instructions from the network and forwards the computer readable program instructions for storage in a computer readable storage medium within the respective computing/processing device.

Computer readable program instructions for carrying out operations of the embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiments.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions-′acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiment was chosen and described in order to best explain the principles of the embodiments and the practical application, and to enable others of ordinary skill in the art to understand the embodiments for various embodiments with various modifications as are suited to the particular use contemplated.

What is claimed is:

1. A method of using a computing device to determine a window size in variate time series data, the method comprising:
receiving, by a computing device, variate time series data associated with a machine learning model;
setting, by the computing device, a moving window size and a standard deviation for the variate time series data;
calculating, by the computing device, a moving window average for the variate time series data;
calculating, by the computing device, a standard deviation across all variate time series data;
sorting, by the computing device, the standard deviations calculated in descending order;
iterating, by the computing device, indices for the standard deviations until the indices have been visited by at least one anchor;
iteratively expanding, by the computing device, each anchor to cover neighbors' anchors which have been visited by previous anchors; and
determining, by the computing device, a window size based upon the expanded anchors.

2. The method of claim 1, wherein the variate time series data is univariate time series data or multivariate time series data.

3. The method of claim 2, wherein the window size is implemented in triplet loss formulation of representation machine learning of the variate time series data.

4. The method of claim 2, wherein the iterating further comprises:
setting a beginning and end of a next window size using a largest standard deviation and current window size.

5. The method of claim 4, further comprising:
marking, by the computing device, the window size positions between the beginning and end.

6. The method of claim 2, further comprising:
iteratively expanding, by the computing device, the moving window size to its neighbors whose standard deviation exceeds a threshold.

7. The method of claim 2, further comprising:
selecting, by the computing device, a next largest standard deviation whose position has not been visited by the previous anchors; and
ending processing, by the computing device, upon visiting all positions in a window-based moving average vector.

8. A computer program product for determining a window size in variate time series data, the computer program product comprising a computer readable storage medium having program instructions embodied therewith, the program instructions executable by a processor to cause the processor to:
receive, by the processor, variate time series data associated with a machine learning model;
set, by the processor, a moving window size and a standard deviation for the variate time series data;
calculate, by the processor, a moving window average for the variate time series data;
calculate, by the processor, a standard deviation across all variate time series data;
sort, by the processor, the standard deviations calculated in descending order;
iterate, by the processor, indices for the standard deviations until the indices have been visited by at least one anchor;
iteratively expand, by the processor, each anchor to cover neighbors' anchors which have been visited by previous anchors; and
determine, by the processor, a window size based upon the expanded anchors.

9. The computer program product of claim 8, wherein the variate time series data is univariate time series data or multivariate time series data.

10. The computer program product of claim 9, wherein the window size is implemented in triplet loss formulation of representation machine learning of the variate time series data.

11. The computer program product of claim 9, wherein the iterating further comprises:
setting a beginning and end of a next window size using a largest standard deviation and current window size.

12. The computer program product of claim 11, wherein the program instructions executable by the processor further cause the processor to:
mark, by the processor, the window size positions between the beginning and end.

13. The computer program product of claim 9, wherein the program instructions executable by the processor further cause the processor to:
iteratively expand, by the processor, the moving window size to its neighbors whose standard deviation exceeds a threshold.

14. The computer program product of claim 9, wherein the program instructions executable by the processor further cause the processor to:
select, by the processor, a next largest standard deviation whose position has not been visited by the previous anchors; and
end processing, by the processor, upon visiting all positions in a window-based moving average vector.

15. An apparatus comprising:
a memory configured to store instructions; and
a processor configured to execute the instructions to:
receive variate time series data associated with a machine learning model;
set a moving window size and a standard deviation for the variate time series data;
calculate a moving window average for the variate time series data;
calculate a standard deviation across all variate time series data;
sort the standard deviations calculated in descending order;
iterate indices for the standard deviations until the indices have been visited by at least one anchor;
iteratively expand each anchor to cover neighbors' anchors which have been visited by previous anchors; and
determine a window size based upon the expanded anchors.

16. The apparatus of claim 15, wherein the variate time series data is univariate time series data or multivariate time series data.

17. The apparatus of claim 16, wherein the window size is implemented in triplet loss formulation of representation machine learning of the variate time series data.

18. The apparatus of claim 16, wherein the iterating further comprises:
setting a beginning and end of a next window size using a largest standard deviation and current window size.

19. The apparatus of claim 18, wherein the processor is further configured to execute the instructions to:
mark the window size positions between the beginning and end; and
iteratively expand the moving window size to its neighbors whose standard deviation exceeds a threshold.

20. The apparatus of claim 16, wherein the processor is further configured to execute the instructions to:
select, by the processor, a next largest standard deviation whose position has not been visited by the previous anchors; and
end processing, by the processor, upon visiting all positions in a window-based moving average vector.
